(19) United States
(12) Patent Application Publication
(10) Pub. No.: US 2026/0138529 A1
(43) Pub. Date: May 21, 2026

(54) ALERT SYSTEM FOR DUMP TRUCK

(71) Applicants: Donald William VanHalteren, Fenelon Falls (CA); Katharina Geraldina VanHalteren, Fenelon Falls (CA)

(72) Inventors: Donald William VanHalteren, Fenelon Falls (CA); Katharina Geraldina VanHalteren, Fenelon Falls (CA)

(21) Appl. No.: 19/392,109

(22) Filed: Nov. 17, 2025

Related U.S. Application Data
(60) Provisional application No. 63/722,115, filed on Nov. 19, 2024.

(51) Int. Cl. B60Q 9/00; B60P 1/16; B60P 1/26

(52) U.S. Cl. CPC B60Q 9/00; B60P 1/162; B60P 1/26

(57) ABSTRACT

An alert system for a dump truck is disclosed. The dump truck has a chassis and a dump body pivotally connected to chassis and adapted to be displaced between a lower position and a raised position. A tailgate of the dump body is adapted to be arranged in a closed position and an open position. The alert system includes at least one sensor to detect at least one of a position of the dump body and a position of the tailgate. The alert system further includes at least one indicator adapted to generate an alert. Moreover, the alert system includes a controller configured to actuate the at least one indicator to generate the alert in response to the dump body being arranged lifted from the lower position and/or tailgate arranged away from the closed position based on input received from the at least one sensor.

### BACKGROUND

### 1. Technical Field

The present disclosure relates, generally, to a dump truck, and more particularly relates to an alert system for a dump truck to alert a driver of the dump truck about a lifted dump body and/or an open tail gate of the dump body.

### 2. Description of the Prior Art

In a conventional dump truck, material such as dirt, sand or gravel is transported from one location to another and then “dumped” on the ground. The material is dumped by elevating one end of the dump bed such that the material slides out the other end. The dump bed is elevated by means of a hoist operated by a hydraulic pump.

In normal operation, once the dump truck driver has dumped the material at a job site, he is to lower the bed before traveling down the highway. It is not uncommon, however, for a driver to leave inadvertently the bed raised. In the worst case scenario, the height of the truck with the bed raised may exceed the height of a bridge or other overhead object. Should a dump truck traveling with the bed in the raised position strike a bridge, the damage to the truck, driver and bridge can be significant.

### SUMMARY

In one aspect of the disclosure, an alert system for a dump truck is disclosed. The dump truck has a chassis and a dump body pivotally connected to chassis and adapted to be displaced relative to the chassis between a lower position and a raised position. The dump body includes a tailgate adapted to be arranged in a closed position and an open position. The alert system includes at least one sensor to detect at least one of a position of the dump body relative to the chassis and a position of the tailgate relative to sidewalls of the dump body. The alert system further includes at least one indicator adapted to generate an alert and mounted inside a cab of the dump truck. Moreover, the alert system includes a controller communicatively coupled to the at least one sensor and the at least one indicator. The controller is configured to actuate the at least one indicator to generate the alert in response to the dump body being arranged lifted from the lower position and/or tailgate arranged away from the closed position based on input received from the at least one sensor.

In some alternative, additional, or optional embodiments, the at least one sensor includes a first proximity sensor configured to determine a presence and absence of the dump body at the lower position, and the at least one indicator includes a first indicator. The first indicator is activated in response to the determination of absence of the dump body at the lower position.

In some alternative, additional, or optional embodiments, the first proximity sensor is a proximity switch adapted to be activated by the dump body when arranged at the lower position.

In some alternative, additional, or optional embodiments, the at least one sensor includes a second proximity sensor configured to determine a presence and absence of the tailgate at the closed position, and the at least one indicator includes a second indicator. The second indicator is activated in response to the determination of absence of the tailgate at the closed position.

In some alternative, additional, or optional embodiments, the dump truck includes a latch connected to the dump body, a pin connected to the tailgate adapted to arrange inside the latch when the tailgate is arranged at the closed position, and a pneumatic cylinder to open and close the latch. The alert system includes an air pressure sensor to monitor a pressure of the pneumatic cylinder. The second indicator remains deactivated when the latch is closed and the tailgate is arranged at the closed position. The second indicator is activated when the tailgate is arranged away from the closed position and/or the latch is open.

In some alternative, additional, or optional embodiments, the opening and closing of the latch is determined based on the pressure, determined by the air pressure sensor, of the pneumatic cylinder.

In some alternative, additional, or optional embodiments, the second proximity sensor is a proximity switch adapted to be activated by the tailgate when arranged at the closed position.

In some alternative, additional, or optional embodiments, the dump truck includes a power take off and a fluid actuator adapted to be engaged and disengaged from the power take off to lower and raise the dump body. The alert system includes a power take off sensor configured to determine an engagement and disengagement of the power take off with the fluid actuator. Moreover, the at least one indicator includes a third indicator arranged to be activated in response to the determination of the power take off being engaged with the fluid actuator.

In some alternative, additional, or optional embodiments, the at least one indicator includes at least one light or at least one buzzer.

In another aspect of the disclosure, a dump truck is disclosed. The dump truck includes a chassis, and a dump body pivotally connected to chassis and adapted to be displaced relative to the chassis between a lower position and a raised position. The dump body includes a tailgate adapted to be arranged in a closed position and an open position. The dump truck also includes at least one sensor to detect at least one of a position of the dump body relative to the chassis and a position of the tailgate relative to sidewalls of the dump body. The dump truck further includes at least one indicator adapted to generate an alert and mounted inside a cab of the dump truck. Furthermore, the dump truck includes a controller communicatively coupled to the at least one sensor and the at least one indicator. The controller is configured to actuate the at least one indicator to generate the alert in response to the dump body being arranged lifted from the lower position and/or tailgate arranged away from the closed position based on input received from the at least one sensor.

In some alternative, optional, or additional embodiments, the at least one sensor includes a first proximity sensor configured to determine a presence and absence of the dump body at the lower position, and the at least one indicator includes a first indicator. The first indicator is activated in response to the determination of absence of the dump body at the lower position.

In some additional, optional, or alternative embodiments, the first proximity sensor is a proximity switch adapted to be activated by the dump body when arranged at the lower position.

In some additional, optional, or alternative embodiments, the at least one sensor includes a second proximity sensor configured to determine a presence and absence of the tailgate at the closed position, and the at least one indicator includes a second indicator. The second indicator is activated in response to the determination of absence of the tailgate at the closed position.

In some additional, optional, or alternative embodiments, the dump truck includes a latch connected to the dump body, a pin connected to the tailgate adapted to arrange inside the latch when the tailgate is arranged at the closed position, and a pneumatic cylinder to open and close the latch. The alert system includes an air pressure sensor to monitor a pressure of the pneumatic cylinder. The second indicator remains deactivated when the latch is closed and the tailgate is arranged at the closed position. The second indicator is activated when the tailgate is arranged away from the closed position and/or the latch is open.

In some additional, optional, or alternative embodiments, the opening and closing of the latch is determined based on the pressure, determined by the air pressure sensor, of the pneumatic cylinder.

In some additional, optional, or alternative embodiments, the second proximity sensor is a proximity switch adapted to be activated by the tailgate when arranged at the closed position.

In some additional, optional, or alternative embodiments, the dump truck includes a power take off, a fluid actuator adapted to be engaged and disengaged from the power take off to raise and lower the dump body relative to the chassis, a power take off sensor configured to determine an engagement and disengagement of the power take off with the fluid actuator, and the at least one indicator includes a third indicator arranged to activated in response to the determination of the power take off being engaged with the fluid actuator.

In some additional, optional, or alternative embodiments, the at least one indicator includes at least one light or at least one buzzer.

### BRIEF DESCRIPTION OF THE DRAWINGS

FIG. 1 is a side view of an example dump truck having an alert system and a dump body arranged at a lower position, in accordance with an embodiment of the disclosure;

FIG. 2 is a side view of the example dump truck of FIG. 1 with the dump body arranged at a raised position, in accordance with an embodiment of the disclosure;

FIG. 3 is a block diagram schematically depicting the alert system of the dump truck of FIG. 1, in accordance with an embodiment of the disclosure; and

FIG. 4 is electrical schematic of an example alert system of the dump truck, in accordance with an embodiment of the disclosure.

### DETAILED DESCRIPTION

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

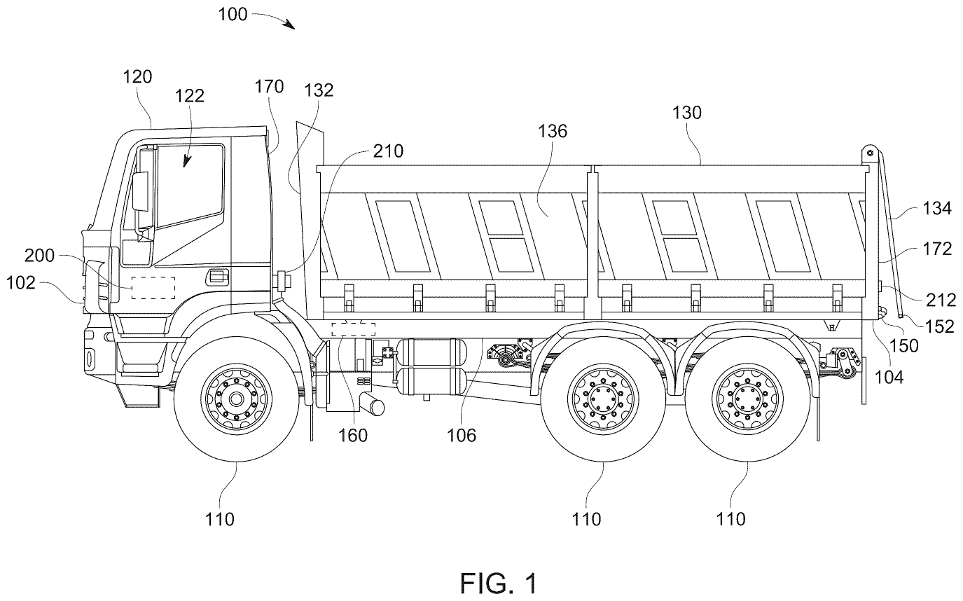

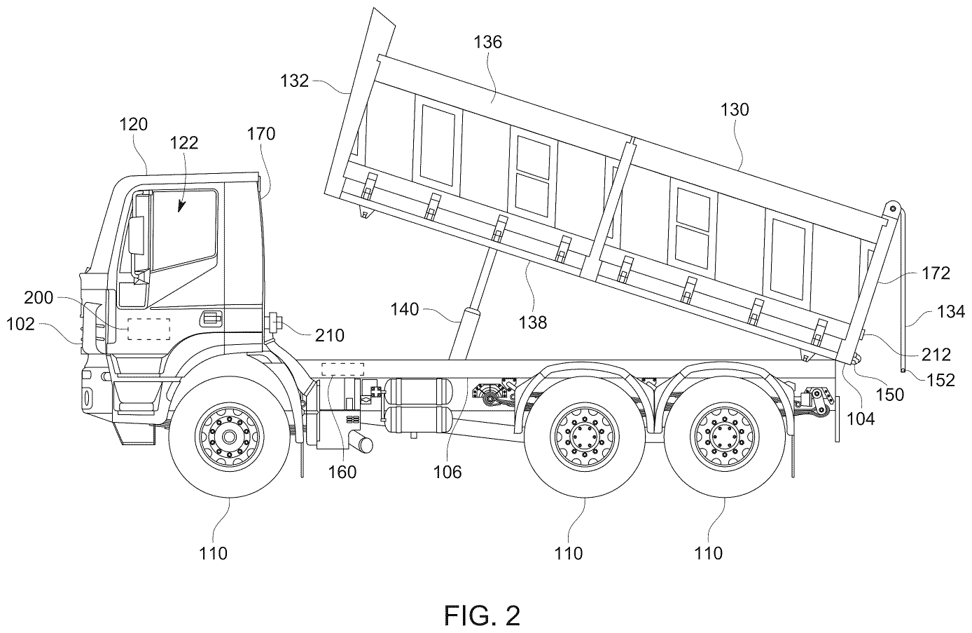

Referring to FIGS. 1 and 2, a dump truck 100 including an alert system 200 is shown, according to example embodiments of the disclosure. As shown, the dump truck 100 includes a front end 102, a rear end 104, a chassis 106 extending from the front end 102 to the rear end 104 and supporting various components of the dump truck 100, and a plurality of wheels 110 supporting the chassis 106 on a surface. The wheels 110 enable the movement of the dump truck 100 over a surface.

Moreover, the dump truck 100 includes a cab 120 arranged mounted on the chassis 106 and extending from the front end 102 towards the rear end 104 in a longitudinal direction of the dump truck 100. The cab 120 defines a passenger compartment 122 having one or more seats to enable a seating of a driver inside the passenger compartment 122 to enable the driver to operate of the dump truck 100. Further, the dump truck 100 includes a dump body 130 pivotally connected to the chassis 106 at a location proximate to the rear end 104, and defines a chamber to store material. As shown, dump body 130 includes a front wall 132 arranged proximate to the cab 120, a tailgate 134 arranged at a rear of the dump body 130, a dump bed/floor 138 extending from the front wall to the rear end 104, and a pair of sidewalls 136 extending from the front wall 132 to the rear end 104 and extending vertically from the dump bed 138. The tailgate 134 is adapted to move between an open position and a closed position. In the open position, the tailgate 134 is arranged away from sidewalls 137 to allow removal of the material stored inside the chamber, while in the closed position, the tailgate 134 is arranged covering contacting the sidewalls 136, closing the opening of the chamber and preventing any removal of the material from the chamber. Further, the dump body 130 includes at least one latch 150 attached at a rear end of the dump body 130 arranged to hold and lock the tailgate 134 in the closed position. For so doing, the tailgate 134 includes at least one pin 152 that engages with the latch 150 and is held by the latch 150 to hold the tailgate in the closed position. To operate the latch 150 and hence to engage and disengage the pin 152 with the latch 150, the dump truck 100 includes a pneumatic cylinder/actuator 162. In embodiments, a latch switch is positioned inside the cab 120 to be operated by the driver to operate the latch 150 to open and close the latch 150.

In embodiments, the dump body 130 is moved to a raised position i.e., tilted relative to the chassis 106 and the tailgate 134 is arranged in the open position to remove the material from the chamber of the dump body 130. Accordingly. to pivot the dump body 130 between the raised position, shown in FIG. 2, and a lowered position, shown in FIG. 1, the dump truck 100 includes a linear fluid actuator 140, for example, a fluid cylinder, having a cylindrical tube and a piston having a piston head arranged inside cylindrical tube configured to reciprocate inside the cylindrical tube. The piston also includes a piston rod having a first end connected to the piston head and a second end arranged outwardly of the cylindrical tube. It may be appreciated that the pivoting of the dump body 130 relative to the chassis is enabled by having the cylindrical tube connected to one of the chassis 106 and the dump body 130 and second end of the piston rod connected to the other of the chassis 106 and the dump body 130. Accordingly, the dump body 130 is pivoted to the raised position by telescopically extending the piston rod outwardly of the cylindrical body, and is moved to the lowered position by telescopically retracting the piston rod inside the cylindrical body. To extend the piston rod relative to the cylindrical tube, a fluid is pumped, at a pressure, inside a head end chamber or a rod end chamber of the cylindrical tube using a fluid pump (not shown). To operate the fluid pump and to introduce the fluid inside the cylinder i.e., fluid actuator 140, to raise the dump body 130, the fluid pump and hence the fluid actuator 140, is connected to a power take-off (PTO) 160 of the dump truck 100.

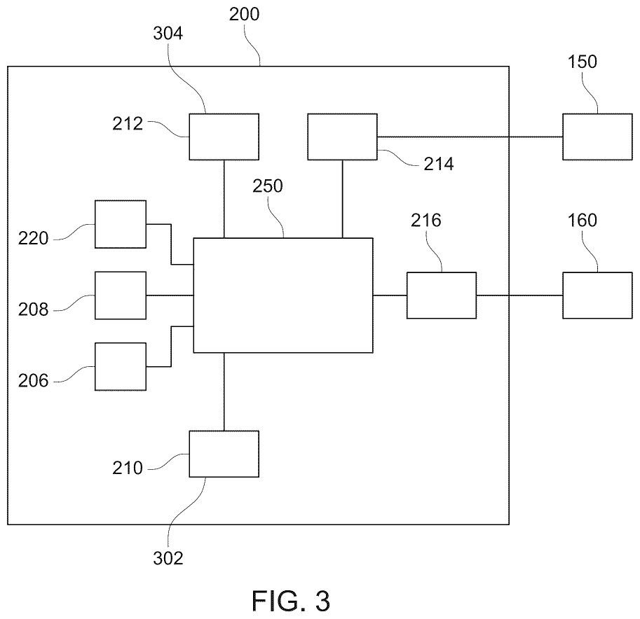

In embodiments, referring to FIG. 3, the dump truck 100 includes an alert system 200 to indicate/inform/alert the driver of the dump truck 100 when the dump body 130 is arranged lifted/tilted from the lower position and/or the tailgate 134 is opened. For so doing, alert system 200 includes at least one sensor to determine the position of the dump body 130 and/or the tailgate 134, and actuate at least one indicator of the alert system 200 depending on the position of the dump body 130 and/or the tailgate 134.

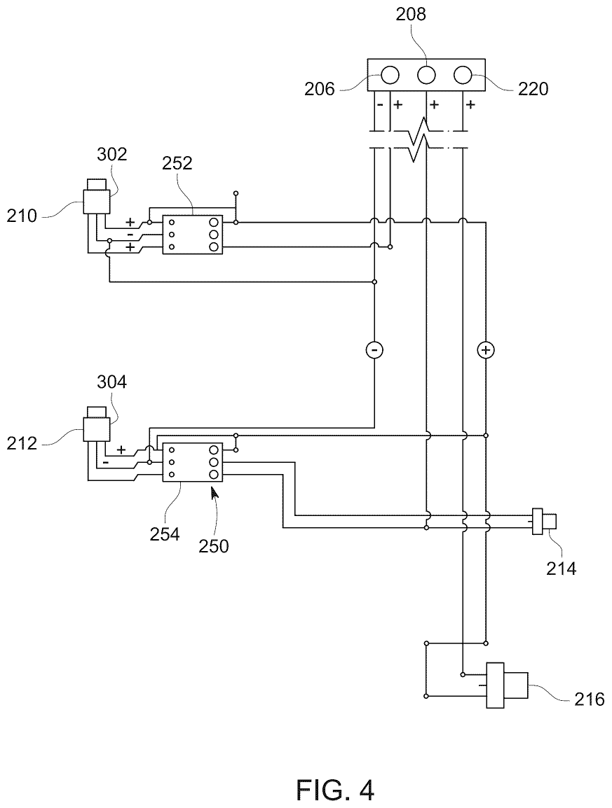

In some embodiments, the at least one sensor includes at least one proximity sensor, for example, a first proximity sensor 210 and a second proximity sensor 212, respectively arranged to determine a position/proximity of the dump body 130 relative to the cab 120 and position/proximity of the tailgate 134 relative to sidewalls 136 and/or dump bed 138, respectively. As shown, the first proximity sensor 210 is arranged at rear of the cab 120, and is configured to detect the presence or absence of the dump body 130 within a predetermined distance of a rear 170 of the cab 120. It may be appreciated that the predetermined distance may correspond to a distance between the cab 120 and the dump body 130 i.e., front wall 132 of the dump body 130 when the dump body 130 is arranged at the lower position. Accordingly, the absence of the dump body 130 within the predetermined distance from the cab 120 indicates that the dump body 130 is arranged lifted relative to the chassis 106 of the dump truck 100. In some embodiments, the first proximity sensor 210 is a proximity switch 302, shown in FIG. 4, adapted to be activated by the dump body 130 when the dump body 130 is arranged at the lower position. Accordingly, lifting of the dump body 130 is determined when the proximity switch 302 is not activated.

In the embodiments, the second proximity sensor 212 is arranged at rear of the dump body 130 and configured to detect the presence or absence of the tailgate 134 at the closed position. In some embodiments, the tailgate 134 is determined to be present at the closed position when a lower end of the tailgate 134 is arranged within a predefined distance of a rear end 172 of the sidewalls 136 of the dump body 130 or arranged tilted relative to sidewalls 136 by less than a predefined tilt angle. Accordingly, the absence of the tailgate 134 within the predefined distance/angle from the sidewalls 136 indicates that the tailgate 134 is arranged opened. In some embodiments, the second proximity sensor 212 is a proximity switch 304 and in such a case, the closed position, the tailgate 134 is arranged activating the proximity switch 304. Accordingly, the presence or absence of the tailgate 134 at the closed position is determined based on the activating of the proximity switch 304 by the tailgate 134.

Further, in some embodiments, the at least one indicator includes a first indicator 206 and a second indicator 208 associated with the dump body 130 and the tailgate 134, respectively. The first indicator 206 is arranged/configured to operated based on input received from the first proximity sensor 210 to indicate/inform the driver about a position of the dump body 130 relative to the chassis 106. In the embodiments, the first indicator 206 includes a light or a buzzer that remains switched off when the dump body 130 is arranged at the lower position, and is switched on when the dump body 130 is lifted from the lower position.

Accordingly, in some embodiments, based on the input received from the first proximity sensor 210, the first indicator 206 is switch on or switched off. For example, the first indicator 206 is switched on upon determination/detection of the absence of the dump body 130 at the lower position, while the first indicator 206 is switched off in response to the dump body 130 being present, based on input from the first proximity sensor 210, at the lower position.

In embodiments, the first proximity sensor 210 is the proximity switch 302, as shown in FIG. 4, and is configured to disable an electrical connection of the first indicator 206 to keep the first indicator 206 switched off/deactivated when contacted and activated by the dump body 130, indicating the presence of the dump body at the lower position, and enables the electrical connection of the first indicator 206 to switch on/activate the first indicator 206 when the dumb body 130 is arranged away from the proximity switch 302, indicating that the dump body 130 is arranged lifted relative to the chassis 106 of the dump truck 100.

Similarly, the second indicator 208 is arranged/configured to be operated based on input, received from the second proximity sensor 212, associated with the opening and closing of the tailgate 134 to indicate/inform the driver about opened and closed tailgate 134. In the embodiments, the second indicator 208 includes a light and/or a buzzer that remains switched off when the tailgate 134 is arranged at the closed position, and is switched on when the tailgate 134 is open i.e., arranged away from associated closed position.

Accordingly, in some embodiments, based on the input received from second proximity sensor 212, the second indicator 208 is switched on/activated or switched off/deactivated. For example, the second indicator 208 is switched on/activated upon determination/detection of the absence of the tailgate 134 at the closed position while the second indicator 208 is switched off/deactivated in response to the tailgate 134 being present, based on input from the second proximity sensor 212, at the closed position.

In some embodiments, the second proximity sensor 212 is the proximity switch 304, shown in FIG. 4, and is configured to enable an electrical connection of the second indicator 208 to switch on/activate the second indicator 208 when tailgate 134 is arranged away from the proximity switch 304, and disables the electrical connection of the second indicator 208 to switch off/deactivates the second indicator 208 when the tailgate 134 is arranged contacting and activating the proximity switch 304. It may be envisioned that tailgate 134 contacts and presses the proximity switch 304 when the tailgate 134 is arranged at the closed position.

In some embodiments, in addition to the input from the second proximity sensor 212, activation or deactivation of the second indicator 208 is based on an input received from an air pressure sensor 214 arranged to monitor a pressure inside the pneumatic cylinder 162 that is operated to open and close the latch 150. Accordingly, the second indicator 208 is switched off/deactivated when a pressure inside the pneumatic cylinder/actuator 162, determined by the air pressure sensor 214 (shown in FIGS. 3 and 4) of the alert system 200, corresponds to a closing of the latch 150 and the tailgate 134 is arranged at the closed position determined based on input received from the second proximity sensor 212, otherwise the second indicator 208 is activated/switched on to indicate that the tailgate 134 is either arranged away from the closed position and/or the latch 150 is open based on input received from the second proximity sensor 212 and the air pressure sensor 214.

In some additional, or optional embodiments, the alert system 200 may include a PTO sensor 216 configured to determine whether the PTO 160 is engaged with or disengaged from an auxiliary equipment, for example, a fluid pump, of the dump truck that supplies fluid to the fluid cylinder/actuator 140. In response to such a determination, a third indicator 220 of the alert system 200 is controlled. For example, in response to the determination, based on input from the PTO sensor 216, that the PTO 160 is engaged with the fluid pump, and hence the fluid actuator 140, the third indicator 220 is activated i.e., switched on to inform the driver about the engaged state of the PTO, while the third indicator 220 is deactivated/switched off when the PTO 160 is arranged disengaged from the fluid pump, and hence the fluid actuator 140. In embodiments, the third indicator 220 includes a light or buzzer. In embodiments, it may be appreciated that engagement of the PTO 160 with the fluid pump and hence the fluid actuator 140 indicates that the dump body 130 is arranged lifted relative to the chassis 106.

In embodiments, as shown in FIG. 3, the alert system 200 includes a controller communicatively coupled to the proximity sensors 210, 212, the air pressure sensor 214, the PTO sensor 216, and the indicators 206, 208, 220 and configured to activate i.e., switch-on or deactivate i.e., switch off the first indicator 206, the second indicator 208, and the third indicator 220 based on the input received from the sensors 210, 212, 216, 214 as per the process described above.

Referring to FIG. 4, an example electrical circuit of the alert system 200 is shown. As shown, the first proximity sensor 210 is the proximity switch 302 connected to the first indicator 206 via a first electrical relay 252. Accordingly, when the dumb body 130 is arranged lifted from the chassis 106, the dump body 130 is arranged away from the proximity switch 302, the first electrical relay 252 enables the electrical connection to the first indicator 206, thereby activating the first indicator 206, thereby informing the driver that the dump body 130 is arranged lifted relative to the chassis 106. Also, in the embodiment shown in FIG. 4, the second proximity sensor 212 which is the proximity switch 304 and the air pressure sensor 214 are connected to the second indicator 208 via a second electrical relay 254. Accordingly, when the pressure in the pneumatic cylinder 162 corresponds to the opening of the latch 150 and/or the tailgate 134 is arranged away from the closed position, the second electrical relay 254 enables the electrical connection to the second indicator 208, thereby activating the second indicator 208, thereby informing the driver that the tailgate 134 is arranged opened and/or the latch 150 is arranged open. Accordingly, the first and second electrical relays 252, 254 together constitute the controller 250 of the alert system 200.

Although the at least one sensor contemplated to include the proximity sensor to determine the position of the dump body 130 and the tailgate 134, it may be appreciated that that any other type of sensor, such as, but not limited to, position sensor, magnetic sensor, angle sensor, or any other suitable sensor, known in the art, that enables a determination the position of the dump body 130 and tailgate 134 may also be used.

In some embodiment, the at least one indicator is arranged inside the cab and mounted to a dashboard. The at least one may be arranged in a line of sight of the driver seating on a driver seat inside the dump truck. In an embodiment, the at least one indicator includes a light source, for example, a light emitting diode (LED). The light source generates a visual alert to the driver of the dump truck. Additionally, or optionally, the at least one indicator may include a buzzer adapted to generate an audio alert and activated by the controller upon meeting one or more criteria mentioned above in the disclosure.

In this manner, the alert system informs the driver of the dump truck about an undesired operating condition of the dump truck and prevents any potential collision of the dump truck.

Although the pressure sensor is contemplated for determining the position of the dump body, it may be appreciated that that any other type of sensor, such as, but not limited to, position sensor, magnetic sensor, angle sensor, or any other suitable sensor, known in the art, that enables a determination the position of the dump body may also be used. In some embodiments, before generating the alert, the controller may determine a speed of the dump truck and may generate the alert only when the dump truck is moving.

Although the disclosure has been described in connection with a preferred embodiment, it should be understood that modifications, additions, and alterations may be made to the disclosure by one skilled in the art without departing from the spirit and scope of the disclosure.

It should be understood that the foregoing description is only illustrative of the aspects of the disclosed embodiments. Various alternatives and modifications can be devised by those skilled in the art without departing from the aspects of the disclosed embodiments.

What is claimed is:

1. An alert system for a dump truck having a chassis and a dump body pivotally connected to chassis and adapted to be displaced relative to the chassis between a lower position and a raised position, the dump body including a tailgate adapted to be arranged in a closed position and an open position, the alert system comprising:
at least one sensor to detect at least one of a position of the dump body relative to the chassis and a position of the tailgate relative to sidewalls of the dump body;
at least one indicator adapted to generate an alert and mounted inside a cab of the dump truck; and
a controller communicatively coupled to the at least one sensor and the at least one indicator and configured to actuate the at least one indicator to generate the alert in response to the dump body being arranged lifted from the lower position and/or tailgate arranged away from the closed position based on input received from the at least one sensor.

2. The alert system of claim 1, wherein the at least one sensor includes a first proximity sensor configured to determine a presence and absence of the dump body at the lower position, and the at least one indicator includes a first indicator, wherein the first indicator is activated in response to the determination of absence of the dump body at the lower position.

3. The alert system of claim 2, wherein the first proximity sensor is a proximity switch adapted to be activated by the dump body when arranged at the lower position.

4. The alert system of claim 1, wherein the at least one sensor includes a second proximity sensor configured to determine a presence and absence of the tailgate at the closed position, and the at least one indicator includes a second indicator, wherein the second indicator is activated in response to the determination of absence of the tailgate at the closed position.

5. The alert system of claim 4, wherein the dump truck includes a latch connected to the dump body, a pin connected to the tailgate adapted to arrange inside the latch when the tailgate is arranged at the closed position, and a pneumatic cylinder to open and close the latch, wherein the alert system includes an air pressure sensor to monitor a pressure of the pneumatic cylinder, wherein the second indicator remains deactivated when the latch is closed and the tailgate is arranged at the closed position, and the second indicator is activated when the tailgate is arranged away from the closed position and/or the latch is open.

6. The alert system of claim 5, wherein the opening and closing of the latch is determined based on the pressure, determined by the air pressure sensor, of the pneumatic cylinder.

7. The alert system of claim 4, wherein the second proximity sensor is a proximity switch adapted to be activated by the tailgate when arranged at the closed position.

8. The alert system of claim 1, wherein the dump truck includes a power take off and a fluid actuator adapted to be engaged and disengaged from the power take off to raise and lower the dump body, and the alert system includes a power take off sensor configured to determine an engagement and disengagement of the power take off with the fluid actuator, and the at least one indicator includes a third indicator arranged to be activated in response to the determination of the power take off being engaged with the fluid actuator.

9. The alert system of claim 1, wherein the at least one indicator includes at least one light or at least one buzzer.

10. A dump truck, comprising:
a chassis;
a dump body pivotally connected to chassis and adapted to be displaced relative to the chassis between a lower position and a raised position, the dump body including a tailgate adapted to be arranged in a closed position and an open position;
at least one sensor to detect at least one of a position of the dump body relative to the chassis and a position of the tailgate relative to sidewalls of the dump body;
at least one indicator adapted to generate an alert and mounted inside a cab of the dump truck; and
a controller communicatively coupled to the at least one sensor and the at least one indicator and configured to actuate the at least one indicator to generate the alert in response to the dump body being arranged lifted from the lower position and/or tailgate arranged away from the closed position based on input received from the at least one sensor.

11. The dump truck of claim 10, wherein the at least one sensor includes a first proximity sensor configured to determine a presence and absence of the dump body at the lower position, and the at least one indicator includes a first indicator, wherein the first indicator is activated in response to the determination of absence of the dump body at the lower position.

12. The dump truck of claim 11, wherein the first proximity sensor is a proximity switch adapted to be activated by the dump body when arranged at the lower position.

13. The dump truck of claim 10, wherein the at least one sensor includes a second proximity sensor configured to determine a presence and absence of the tailgate at the closed position, and the at least one indicator includes a second indicator, wherein the second indicator is activated in response to the determination of absence of the tailgate at the closed position.

14. The dump truck of claim 13, wherein the dump truck includes a latch connected to the dump body, a pin connected to the tailgate adapted to arrange inside the latch when the tailgate is arranged at the closed position, and a pneumatic cylinder to open and close the latch, wherein the alert system includes an air pressure sensor to monitor a pressure of the pneumatic cylinder, wherein the second indicator remains deactivated when the latch is closed and the tailgate is arranged at the closed position, and the second indicator is activated when the tailgate is arranged away from the closed position and/or the latch is open.

15. The dump truck of claim 14, wherein the opening and closing of the latch is determined based on the pressure, determined by the air pressure sensor, of the pneumatic cylinder.

16. The dump truck of claim 13, wherein the second proximity sensor is a proximity switch adapted to be activated by the tailgate when arranged at the closed position.

17. The dump truck of claim 10, wherein the dump truck includes
a power take off,
a fluid actuator adapted to be engaged and disengaged from the power take off to raise and lower the dump body relative to the chassis,
a power take off sensor configured to determine an engagement and disengagement of the power take off with the fluid actuator, and
the at least one indicator includes a third indicator arranged to be activated in response to the determination of the power take off being engaged with the fluid actuator.

18. The dump truck of claim 10, wherein the at least one indicator includes at least one light or at least one buzzer.
